(19) United States
(12) Patent Application Publication
(10) Pub. No.: US 2003/0128657 A1
(43) Pub. Date: Jul. 10, 2003

(54) Rotate shift code division multiplex communication system

(76) Inventors: Noriyoshi Kuroyanagi, Higashiyamato-shi (JP); Naoki Suehiro, Tsukuba-shi (JP); Masakazu Takahashi, Kanagawa (JP)

Correspondence Address: Koda & Androlia, Suite 3850, 2029 Century Park East, Los Angeles, CA, 90067-3024, US

(21) Appl. No.: 10/169,317

(22) PCT Filed: Sep. 10, 2001
(86) PCT No.: PCT/JP01/07832

(30) Foreign Application Priority Data
Sep. 12, 2000 (JP) 2000-318600
Sep. 18, 2000 (JP) 2000-321842

(51) Int. Cl. H04J 9/00

(52) U.S. Cl. 370/205; 375/130; 375/242

(57) ABSTRACT

A system using a transmitter which comprises means of generating 4 extended sequences E_{A0}, E_{A1}, E_{B0} and E_{B1} using a set (A₀,A₁) of auto-complementary sequences with length L chips consisting of complete complementary sequences and another similar set (B₀,B₁), and means of generating a transmitting frame s_{P} obtained by multiplying a cascaded sequence Ê_{A} made of extended sequences E_{A0} and E_{A1} by a pilot information \hat{p}, generating a transmitting frame s_{D} obtained by multiplying a cascaded sequence Ê_{B} made of extended sequences E_{B0} and E_{B1} by data b, synchronously adding both the transmitting frames to produce a symbol frame, and transmitting a carrier wave modulated thereby, and a receiver which comprises means of applying a front portion r₀ of the synchronously received baseband frame demodulated by above described carrier wave to matched filters M(A₀) and M(B₀), and applying a rear portion r₁ of the synchronously received frame to matched filters M(A₁) and M(B₁), and means of generating a pilot-response-matrix {p} and a received data-response-matrix Φ, both made of the outputs of M(A₀) and M(A₁), and of the outputs of M(B₀) and M(B₁) respectively, and generating an estimate \tilde{b} of transmitted data.

### FIELD OF THE INVENTION

The present invention relates to a communications system that uses spread spectrum modulation to enhance the resistance of the system to interference noise, giving an especially detrimental effect among the noise admixed in the transmission process. The present invention also relates to a communications system that uses baseband pulse modulation or bandpass type data modulation so as to enforce resistance to colored noise.

### BACKGROUND ART

In spread spectrum communications, a spreading code sequence is modulated by transmission data so that the data with a relatively narrow band spectrum, is spread over a wide frequency band and then transmitted. Such a communications system is superior in that the transmission power per unit frequency is low, interference to other communications can be kept at a relatively low level, and in that the system has an inherent strong resistance to ambient noise that is admixed in the transmissions process, e.g., general incoming noise and interference noise incoming from mobile stations or interfering stations other than a desired station. However, because communications performed by numerous stations share the same bandwidth, arises a problem such that communications performance degradation caused by the interference noise tends to be a predominant factor.

FIG. 10 is a block diagram illustrating the general construction of a mobile communications system which performs spread spectrum communications via a radio communications channel. Here, a transmitter TX modulates a spreading code sequence generated by a sequence generator 1, by multiplying it by binary transmission data b, thus producing a baseband transmission output s(t). Transmitter TX further modulates this baseband transmission output s(t) using a carrier waveform of a frequency f₀ which is generated by an oscillator 2, so that the carrier waveform containing data b is spread over a spectrum. Transmitter TX then transmits this waveform to a receiver RX via a radio communications channel. Furthermore, a pseudo-noise (PN) sequence whose period is the same as the bit length of data b is generally used as the spreading code sequence. In the following description, Gold-sequences (hereafter simply referred to as “G sequences”) will be used as an example and because they are the most common type in many PN sequences.

Receiver RX sends the spread-spectrum-modulated signal to an amplifier 3 via an antenna (not shown in the figures), amplifies the signal up to a required level, and then frequency-mixes the amplified signal with a local signal f_{L} (=f₀) frome a local oscillator 4. Receiver RX then demodulates the resultant signal into a baseband received spread signal r(t) by passing through a low pass filter 5. In other words, coherent demodulation or non-coherent demodulation is performed.

This baseband spread signal r(t) is inputted into a multiplier 7 with an M sequence that is the same as the sequences used by transmitter TX and generated by the sequence generator 6. The resultant multiplied output is then integrated by an integrator 8 for the period of the sequence length of the M sequence (1 frame), to obtain a matched filter output. This output is detected by a detector 9 at the end of the frame, and the received binary data \hat{b} is then detected by means of a hard-decision function which compares this output with a threshold value. A control signal created based upon this detected data is inputted into a control terminal of sequence generator 6 via a synchronization detector 10, and the generating timing of G sequence is controlled so that the sequence phase may be synchronized with the received signal. Furthermore, in receiver RX shown in FIG. 15, the arrangement of the multiplying functions provided by local oscillator 4 and sequence generator 6 is often exchanged each other; however, the overall demodulation function remains the same.

FIG. 11 schematically shows spectra of a signal being transmitted. In FIG. 11(a), reference numeral 11 denotes a spectrum of a spectrum spread modulated signal, and reference numeral 12 denotes a spectrum of admixed environmental noise. When the receiver demodulates (despreads) this signal and noise using the G sequence, the spectrum spread modulated signal 11 which has been spread over a wide frequency band as shown in FIG. 11(b) is converted into a narrow-band signal 13, and the environmental noise 12 is converted into a signal 14 which has been distributed over a wide frequency band. Accordingly, this communications method can suppress the disturbance due to the environmental noise.

FIG. 12 is a diagram showing the relationship between a G (impulse) sequence g_{I} and binary information in a conventional direct sequence spread spectrum communications system (DS-SS). This is an example in which the sequence length L=7 (chips). In this figure, b indicates the binary data that is to be transmitted, T indicates the period of the data b (frame period), T_{C} indicates the chip period, and s_{I}(t) indicates an output obtained by multiplying g_{I}(t) by b. A transmission frame s(t) is a transmission baseband waveform obtained by replacing the individual impulses of s_{I}(t) with rectangular waveforms. Thus, g_{I}(t) and g(t) are given by:

$$\begin{matrix}{g}_{I} ( t ) = {\sum }_{i = 0}^{L - 1} {c}_{i} δ ( t - {iT}_{C} ) 0 \leq t \leq T & ( 1 ) \\ g ( t ) = {\sum }_{i = 0}^{L - 1} {c}_{i} {q}_{1} ( t - {iT}_{C} ) 0 \leq t \leq T & ( 2 ) \\ \begin{matrix}{q}_{1} ( t ) = 1 & \vert t \vert \leq \frac{{T}_{C}}{2} \\ = 0 & \vert t \vert \leq \frac{{T}_{C}}{2}\end{matrix} \} & ( 3 )\end{matrix}$$

where cᵢ (i=0, 1, 2, . . . , L−1: L is the sequence length of a spreading sequence) is the i-th chip amplitude of the spreading sequence, δ is a delta function, and q₁ is a square waveform function. As shown in the figure, a square waveform is sent out in response to a value “1”, and an inverted output g(t) is sent out in response to a value “0”. Actually, s(t) is transmitted after converting baseband signal into a radio frequency band whose bandwidth is limited to f_{C}=T_{C}⁻¹. Accordingly, the frequency bandwidth occupied by the data signal is substantially f_{D}=1/T, and that of the spread transmitting baseband signal s(t) is substantially f_{C}=T_{C}⁻¹. In this case, the following equation is established:

f_{c}=Lf_{D} (4)

Furthermore, instead of using the rectangular waveform q₁(t) given by Eq.(3), it is possible to use such a waveform q₁′(t) that the auto-correlation function at an adjacent sampling point may take zero (called the sampling function, and the DFT conversion of q₁(t) has a cosine roll-off characteristic). In this case, if the receiver prepares the same waveform q₁′(t) as that of the transmitting side and performs correlative demodulation using the waveform, the desired waveform components of the received signal will be restored as the impulse sequence indicated by Eq.(2). The signal can be detected by despreading this impulse sequence with g_{I}(t). Since the spread-spectrum modulated signal thus occupies an extremely broad frequency bandwidth, colored noise power (component in-phase with the signal g(t)) can be suppressed to 1/L, so this system is noise resistant.

In general, however, L>>1 holds good, and in spite of the use of a bandwidth L times as large as that of the data signal, the number of simultaneous calls Kₛ is given by Kₛ<<L (a fraction of the value L); the simultaneous transmission capacity/Hz is (Kₛ/L) times as large as that of a time-division multiplex system (TDMA). Consequently, this system is disadvantageous in terms of transmission frequency-band utilization-efficiency is generally extremely low compared to that of a time-division multiplex system.

Thus, the reason why the number of simultaneous calls Nₛ cannot be set to a very large value compared to L is that the cross-correlation coefficient between G sequence g₀(t) assigned to the desired station and different G sequence g_{K}(t) (k≠0) assigned to another mobile station cannot be sufficiently small. Furthermore, the suppressing effect on colored noise or transmission noise accompanying fading or delayed waveforms caused by multiple reflections (multipath) during the transmission process is also generally insufficient. Essentially these factors reduce the frequency utilization efficiency of the conventional spread spectrum communication system.

The process gain G_{P} of the conventional direct sequence spread spectrum communications system is given by:

G_{P}=10 log₁₀L (5)

If an incoming noise has a single frequency, and is in phase with the sequence g₀(t), the demodulated noise power obtained after the demodulation by the receiver (an output from integrator 8 in FIG. 15) will be 1/L times as much as the incoming noise power (an output from the LPF 5 in FIG. 9), as described above. However, the mean value of the cross-correlation between different G sequences is given by ρ=1/\sqrt{L}, but the worst correlation value is significantly larger than the mean. Because sequences g₀(t) and gₖ(t) are modulated by mutually independent transmission information, and the cross-correlation varies with mutual frame phases of these sequences. As a result, numerous interference waveforms with a large cross-correlation are applied to the receiver over a long period of time, thus significantly degrading the code error rate. Therefore, this is a problem such that the number of simultaneous calls Nₛ cannot be set to a large value.

Moreover, the error rate is further forced to increase by an increase in self-interference noise and inter-station interference noise which are caused by delayed waveforms resulting from multiple reflections (multipath) during transmission, or by a decrease in the receiving signal to noise ratio (SNR) associated with fading. Principally these factors reduce the frequency utilization efficiency of the CDMA system. The present invention relates to a technique that can deal not only with the narrow-band noise but also with the inter-station interference noise (wide-band noise) as described above or inter-cell interference noise generated by similar communications carried out in other cells (service areas in the mobile communications system).

The inventor already applied a patent entitled by “pilot assisted CDMA communications system(application number PH11-154226) with interference separating function” in order to suppress the above-described interference noise and increase the frequency-utilization-efficiency simultaneously. A paper [N.Suehiro, et al. “High Rate Information Transmission Based on Multipath Estimation and Signal Convolution in Approximately Synchronized CDMA Systems Without Co-Channel Interference” WPMC'99] was also presented. In these works, such examples were described that a transmitter uses 2 complementary sequence sets (A₀,A₁) and (B₀,B₁) which compose complete complementary sequences mutually, and generates a transmitting frame by a method of modulating 2 orthogonal carrier waveforms f₀ and f₁ by these sets and then transmit them. In this embodiment, the pilot information \hat{p} modulates (A₀,A₁), the data information b modulates (B₀,B₁), and \hat{p}A₀ and bB₀ modulate f₀, \hat{p}A₁ and bB₁ modulate f₁, to generate the transmitting frame by adding the both modulated outputs. The transmission process produces delayed waveforms due to many multipaths generally. Each frame is converted into a waveform(flock-frame) made of one group including these delayed waveforms. The flock-frame arrives in a receiver. In this case, the sum of the outputs of the matched filters M(A₀) and M(A₁) at the receiver generates only a pilot associated correlation component Λ_{P}[={p}], and the sum of the outputs of the other matched filters M(B₀) and M(B₁) generates only a correlation component Λ_{D}[=Φ] associated with the data b, because of the complete complementary characteristic of (A₀,A₁) and (B₀,B₁), even if there is a delay time (τ) between the direct waveform (or, the main waveform of the demodulation object) and a delayed waveform. As a result, an estimate \tilde{b} of a transmitted data b can be obtained as a value without being subjected to influence of multipath, when using Λ_{P} and Λ_{D}. Consequently, the components of \hat{p} and b can be isolated perfectly.

But, a phase deviation (Δ θ) of the carrier wave arises associated with delay time (τ) between the above-described direct wave and delayed wave generally. When τ and Δ θ occur simultaneously, their effects to these baseband demodulated outputs are different depending on the carrier waves. It results in that the correlation function of A₀ and B₁ and the correlation function of A₁ and B₀ do not cancel each other, and as a result, for example, a component of Λ_{D} mixes with the sum of the outputs of M(A₀) and M(A₁) to prevent the above-described perfect separating function given by Λ_{P} and Λ_{D}. Consequently, estimate \tilde{b} is deteriorated, and the detection of accurate data information b becomes impossible.

The present invention provides a cyclically shifted code division multiple access communications system which can perform to detect accurately data b, even if the phase deviation (Δ θ) of the carrier waveforms occurs simultaneously with time delay (τ) between a direct wave and a delayed wave, because the imperfect demodulation operation in a receiver is avoided.

### DESCRIPTION OF THE INVENTION

Since in the invention given in Claim 1 of a cyclically shifted code division multiple access communications system concerning the present invention, a transmitter generates a pilot frame and a data frame using auto-complementary sequence sets (A₀,A₁) and (B₀,B₁) which compose complete complementary sequences each other, arranges A₀ and B₀ on the 1-st frame time position, similarly A₁ and B₁ on the 2-nd frame time position, and transmits all of them using the same carrier wave f₀, the sum of the correlation function between A₁ and B₀ and the correlation function between A₀ and B₁ results in taking zero in the demodulation process of a receiver. That is to say, any influence to the correlation functions due to above-described τ and Δ θ does not generate, because the time positions of A₀ and B₁ are different each other and a common carrier wave is used for all of them. On the other hand, the frequency-utilization-efficiency does not reduce although the occupied time duration width is twice as long as that used by the existing systems, since it uses only f₀ instead of using f₀ and f₁ as the carrier waves. In short, it is useful to realize an operation which can perfectly separate Λ_{P} and Λ_{D} without any frequency-utilization-efficiency reduction.

The invention given in Claim 2 of a cyclically shifted code division multiple access communications system concerning the present invention offers a method of transmitting L multiplexed data bₙ(n=0, 1, 2, . . . L−1) corresponding to the length L of respective complementary sequences by using perfect separating function in Claim 1. Since in this system plural data frames are generated by such a method as modulating a cascaded sequence Ê_{B}(n) consisted of the cyclically shifted frames [B₀(n),B₁(n)] by bₙ, and said data frames and the above-described pilot frame are summed up, and then the resultant output is transmited, it is effective to realize the multiple transmission of L bits on the time duration used in the system of Claim 1.

The invention given in Claim 3 of a cyclically shifted code division multiple access communications system concerning the present invention was made in order to respond to the transmission demand of a large number (K) of users in an identical cell, because Claims 1 to 2 offer transmission systems for 1 user. This system uses such a transmission method that, for example, the system produces a core sequence KA₀(KA₁) with time width T_{G} having a comb spectrum characteristic occupying L frequency slots by repeating K times of A₀(A₁) which is a auto-complementary sequence, and produces a cascaded sequence Ê_{AK} using KA₀ and KA₁. In the same way, the system produces similar sequences by making sequences A₁, B₀ and B₁ so as to have the same spectrum. The carrier wave for uₖ is designed to be fₖ=f₀+kf_{G}, where f_{G}=T_{G}⁻¹ is the shift frequency. The transmitter of uₖ modulates cascaded sequences Ê_{AK} and Ê_{BK} on fₖ made of the above-described core-sequences, by pilot \hat{p}ₖ and data bₖ, and sum up them and then transmit the resultant output. This method is effective to realize frequency division multiple transmission which can transmit K user data with high frequency efficiency without interfering each other.

Since the invention given in Claim 4 a cyclically shifted code division multiple access communications system concerning the present invention is a system which transmits L bit data using the cyclically shifted sequence in Claim 2, it is effective that the system of Claim 4 has L times as large frequency-utilization-efficiency as that of the system of Claim 3.

The invention given in Claim 5 of a cyclically shifted code division multiple access communications system concerning the present invention is to realize an advantageous effect in a system design such that the transmission capacity each user utilizes may be flexibly changed by allocating an arbitrary number of the orthogonal carrier waves to respective users shown in Claims 3 and 4.

The invention given in Claims 6 and 7 of a cyclically shifted code division multiple access communications system concerning the present invention offers a system that the pilot frame shown in Claims 1 to 3 is transmitted once per N frames, and data frame using (A₀,A₁) modulated by data bₙ on the other N−1 frames, and the data frame using (B₀,B₁) are summed up, and then the resultant output is transmitted. In this case, the frequency-utilization-efficiency can be approximately doubled, if a relation N>>1 is taken.

### BRIEF DESCRIPTION OF THE DRAWINGS

FIG. 1 is an illustration of intra-cell transmission paths in a CDMA mobile communications system. FIG. 1(a) is a view showing the up-link transmission paths, and FIG. 1(b) is a view showing the down-link transmission paths.

FIG. 2(a) is a view showing transmitting frame format, and FIG. 2(b) is a view showing receiving frame format.

FIG. 3 is a view showing the correlation property of complementary sequences.

FIG. 4 is a view showing basic composition of transmitting symbol frames.

FIG. 5 is a view showing the front components of the transmitting and receiving symbol frames for data.

FIG. 6 is a view showing the data frame composition of a chip shift multiplex system.

FIG. 7 is block diagrams of a transmitter and a receiver circuits according to the first embodiment of the present invention. FIG. 7(a) is a block diagram of the transmitter circuit TX, and FIG. 7(b) is a block diagram of the receiver circuit RX.

FIG. 8 is a diagram showing the pilot and the data frame compositions of a multiplex system using comb-formed orthogonal frequencies.

FIG. 9(a) is a block diagram showing a transmitter circuit according to the second embodiment, and FIG. 9(b) is a block diagram showing a receiver circuit according to the second embodiment.

FIG. 10 is a block diagram showing a general configuration of a spread spectrum mobile communications system.

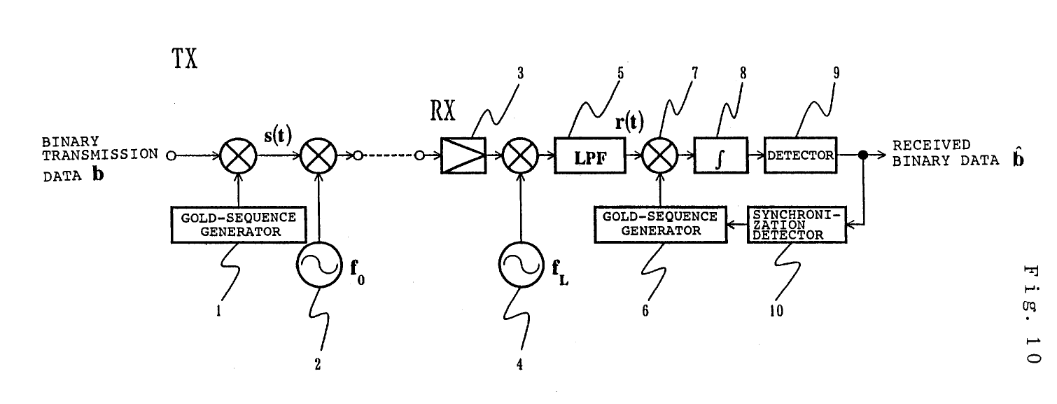

FIG. 11 is a schematic view of spectra of signals being transmitted.

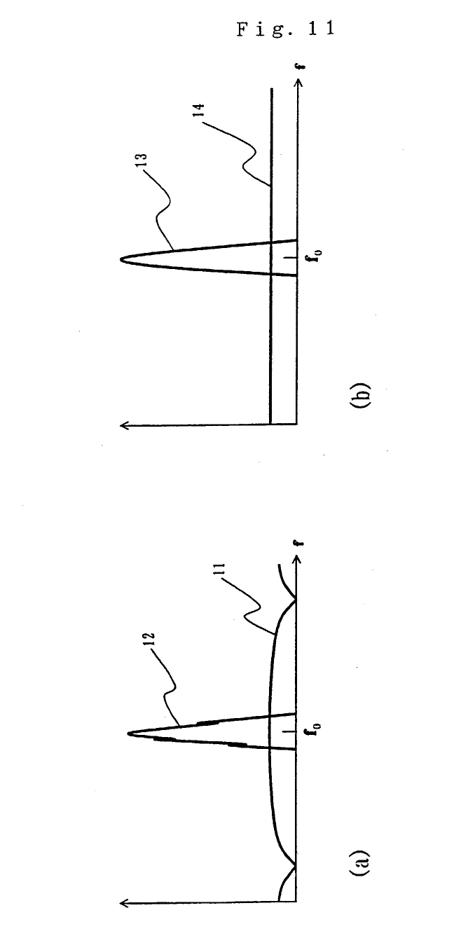

FIG. 12 is a diagram showing relation between binary information and transmitting frame signals in a conventional direct-sequence spread-spectrum communications system.

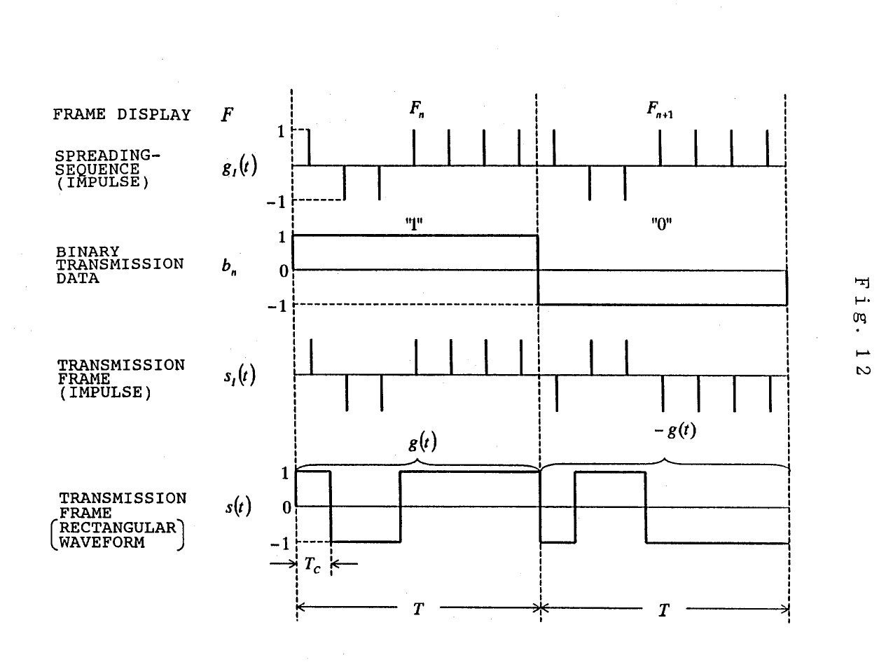

### THE BEST MODE FOR CARRYING-OUT OF THE INVENTION

The present invention is to overcome the above described disadvantages of CDMA communications systems which are vulnerable to the multipath and interference waves. According to the present invention, a transmitter has a function of transmitting pilot frames, and a receiver has a function of removing interfering components due to the multipath and interference waves contained in data frames by using received response information obtained from pilot frames. Here, the main description is carried out by referring to a mobile communications system which indicates a large effect when this invention is applied. In the system, conversion to a radio frequency band such as PSK is performed after spectrum spreading modulation(SS).

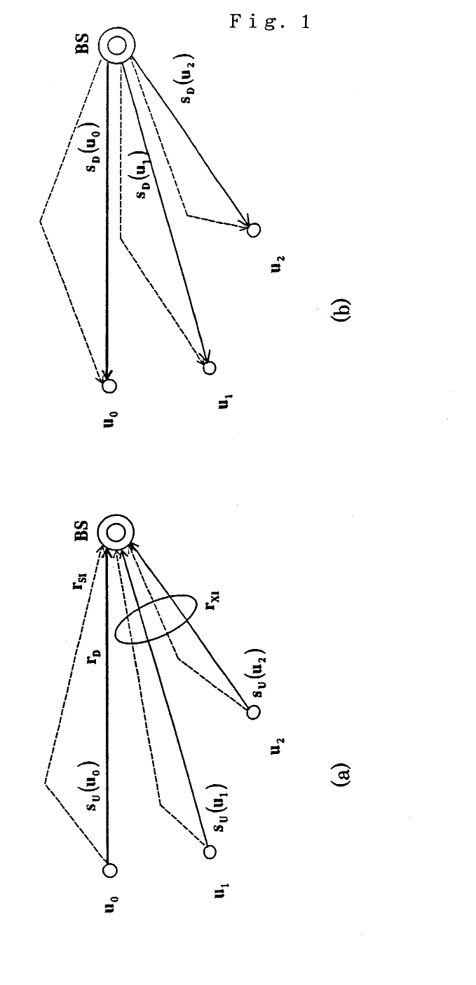

FIG. 1 is an illustration for supplementary explanation of the present invention showing intra-cell transmission paths of a CDMA mobile communications system. The up-link transmission in FIG. 1(a) shows that a mobile station uᵢ (i=0, 1, 2 . . . K) (hereafter referred to as a “user station”) transmits a transmitting wave sᵤ(uᵢ) to a base station BS. If the 0-th user u₀ is assumed to be a desired station, the received wave r_{D} that is a direct wave arrived at base station BS is the desired wave. In this case, the dotted lines indicate multipath delayed wave. A delayed wave generated by the desired wave is a self-interference wave r_{SI}. On the other hand, the transmitted waves from the user stations (also referred to as interference stations) other than the desired station are received as inter-station interference waves r_{XI}. These interference waves include not only direct waves but also multipath delayed waves as shown in the figure. Thus, a received interference wave r_{I} is the sum of the self-interference waves and the other-station interference waves. If all the received waves are denoted as r, it is represented as:

r(t)=r_{D}(t)+r_{I}(t) (6)

r₁(t)=r_{SI}(t)+r_{XI}(t) (7)

FIG. 1(b) shows down-link transmission paths, where multipath delayed waves are also generated as shown by the dotted lines. Further, the waves user station u₀ received includes not only the transmitted wave S_{D} (u₀) and its delayed waves, shown in the figure, but also waves transmitted to another station s_{D}(uᵢ) (i≠0) and its delayed waves, which are not shown. In the down-link transmission, it takes the same time for the interference waves and the desired waves to reach desired station u₀. Accordingly, if only the direct wave is considered, then all the interference waves are synchronously received, resulting in synchronous transmission, thus it reduces interference degradation compared to the up-link asynchronous transmission.

If there is an object blocking a direct wave, a delayed wave may be demodulated instead of the direct wave. In this case, several interfering waves due to multipath precede the wave to be demodulated. In the following, a system design will be described for the up-link transmission, which is technically more difficult, by assuming, for convenience, that the preceding waves are omitted (without loss of generality).

In the following, a case where only one user operates is considered. Transmitter TX modulates a spreading-sequence g(i)=[c₀,c₁,c₂, . . . ,c_{L-1}] with length L and period T_{D}(=LT_{c},T_{c}: the chip time width) by a transmitting data b. This resultant modulated output s(i) modulates a chip waveform w(t) (normally a square waveform with a chip time width or a sampling function waveform of \sqrt{ƒ} characteristics is used.) to generate a baseband transmitting frame s(t). s(t) modulates a carrier wave fₐ to generate a radio-band transmitting wave sₐ(t). It is also assumed to transmit a modulated frame by the pilot-information \hat{p} instead of b synchronously or once in a while, without being subjected to interference due to the data-frames described above.

A received input rₐ(t) is applied to receiver RX at the base-station. Input rₐ(t) is obtained by adding noise to a signal which is made by giving attenuation and distortion to radio-band transmitting waveform sₐ(t), and it is converted into baseband received signal r(t) by a local carrier wave \hat{f}ₐ synchronized with transmitted carrier wave fₐ. The attenuation and distortion added to the transmitting wave are compensated for by an equalizing circuit. Accordingly, if signal r(t) is assumed to be an output from the equalizing circuit, it may be expected that this signal contains the baseband transmitting wave as it is. It may be assumed that the transmitting wave generates M multipath delayed waves and that the frequency distortion is equalized (the attenuation of delayed waves is not compensated.). In a case where a shift-extended-frame, which will be described later, is used as spreading sequence, the baseband received wave is given by:

r*(t)=r_{f}*(t)+x(t) (8)

$${r}_{f}^{*} ( t ) = {\sum }_{m = 0}^{M} {i}_{m} bg ( t - {mT}_{C} ) \qquad ( 9 )$$

where r_{f}(t) denotes a received flock frame composed of the sum of the direct and delayed waves which have been generated by a transmitting wave (the flock frame is normally accompanied by a subscript f), and μₘ denotes the signal amplitude of the m-th delayed waveform, (m may take the negative value, but here it makes m a positive, for the convenience of the description) which is generally a complex due to the phase difference between the transmitted and received carrier wave. In the following description, the value for the desired station is normalized as μ₀=1. x(t) denotes an additive white Guassian noise and includes residues due to incompletely equalized distortion. Further, the mark * which shows the frame position of the direct wave in the received wave and denotes the components on the synchronously received frame with time width T_{D}.

Receiver RX generates a correlation output between input signal r(t) and receiver chip waveform w(t). This correlation output is a chip impulse sequence produced at successive chip period.

$$\begin{matrix}{r}^{*} ( i ) = {r}_{f}^{*} ( i ) + x ( i ) \\ {r}_{f}^{*} ( i ) = {\sum }_{m = 0}^{M} {μ}_{m} bg ( i - m )\end{matrix} \} \qquad ( 10 )$$

where i and m are used as the discrete-value representation of the time variable t=iT_{c} and delay time Tₘ=mT_{c}, respectively.

The received frame as described above modulated by the transmitting data b is denoted by r_{D}(i), and the received frame modulated by pilot signal \hat{p} instead of transmitting data b is denoted by rₚ(i).

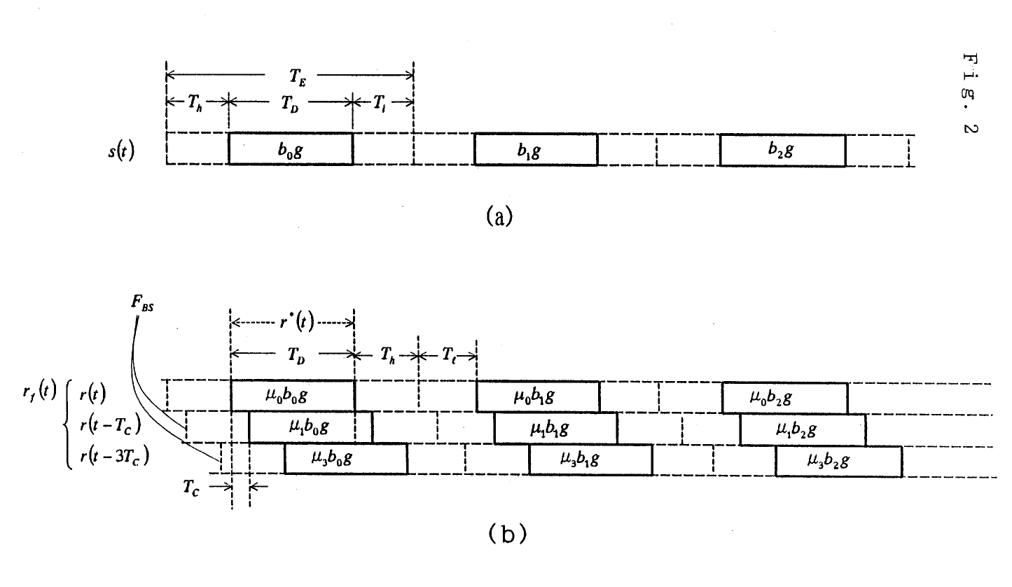

In the following, let us explain a frame composition of baseband transmitting and received signals used in the embodiment with FIG. 2. Here, it is considered that one user u₀ transmits transmitting signal s(t), and demodulates received signal r(t) at a base-station. As shown in FIG. 2(a), transmitting wave s(t) is composed of a sequence of extended frames with an extended period T_{E}. The extended frame E(i) has such a structure that a header (length Lₕ, time width Tₕ) and a tail (length Lₗ, time width Tₗ), are added to the front and the rear outsides of the core sequence g(i) (length L, time width T_{D}). If the header and tail use a rear portion and a front portion of core sequence g(i), a portion with time width T_{D} on an arbitrary position of extended frame E(i) becomes a cyclically shifted sequence of g(i). In this case, extended frame E(i) becomes a cyclically extended sequence. Let us call here E(i) a shift extended sequence. User u₀ produces baseband output s(t) by modulating respective extended sequences E(i) with extended period T_{E} by transmitting data b₀, b₁, b₂, . . . , modulating a carrier wave by s(t), and then transmits the resultant output output.

This transmitting signal generates multipath delayed waves in the transmission process. The received baseband waves including these delayed waves are shown in FIG. 2(b). The received signal is the sum of these waves. As described above, signal r*(i) with time width T_{D} synchronized with a main wave in the received waves is called a synchronously received frame. This frame portion is extracted by synchronizing signal e_{R}. In this frame, a main wave μ₀b₀g(i) and the self-interference-waves [in the Figure are shown μ₁b₀g(i−1) and μ₃b₀g(i−3), and at this embodiment μ₂=0 is assumed.] are contained. The following condition is set so that interference waves on the adjacent frames do not get mixed in the synchronously received frame.

|τ₀ₖ|+(MT_{C})<Tₕ,Tₗ (11)

(k=0, 1, 2, . . . K−1)

where τ₀ₖ indicates the timing deviation between the received waves from user u₀ and Uₖ. Then, if the relative transmitter timing for the transmitting frames is controlled by the base station, timing τ₀ₖ can be restrained from taking an excessively large value. MT_{C} indicates a delay time from the main wave to the M-th delayed wave, and the upper limit depends on the natural environment of the cell. Consequently, appropriate selection of time width Tₕ enables so that r*(i) may not include a boundary F_{BS} produced with the adjacent frames as shown in FIG. 2(b). It also enables a demodulating operation be performed under such a quasi-synchronization condition. This is an inevitable condition required for avoiding the disturbance due to interfering wave components coming from other stations, which will be described later. A preceding wave (m<0) also becomes an interfering wave generally for a case in which the main wave is one of the delayed waves but not the direct wave. In this case, the tail l plays a role so as to avoid the above-described disturbance. Here it is explained for the simplicity as m≧0. Considering the existence of the preceding waves, let us here explain by assuming Tₗ=Tₕ. All the interfering waves contained in the synchronously received frame are viewed as cyclically shifted sequences of the main wave, as long as the above-described quasi-synchronization condition is maintained. That is to say that the odd-correlation output is not generated in the matched filter output in a demodulation process, since there is no influence caused by adjacent frames.

Now, consider a case in which a synchronously received pilot-flock-flame is applied to a matched filter that matches to core sequence g(i), the matched filter output is represented as follows.

$$\begin{matrix} {Λ}_{f} ( j ) = {r}_{Pf}^{*} ( i ) * \overline{g ( i )} = {\sum }_{S = 0}^{L - 1} {p}_{s} δ ( j - s ) \\ {p}_{s} = {\sum }_{m = 0}^{M} {μ}_{m} {λ}^{m} ( s ) \\ {λ}^{m} ( j ) = \frac{1}{L} {\sum }_{i = 0}^{L - 1} {c}_{i} \overline{{c}_{i + m - j}} ( j + m - j : mod L )\end{matrix} \} \qquad ( 12 )$$

Where λ^{m}(j) denotes the (m−j)-th shift auto-correlation value of g(i), and pₛ denotes the value which represents an element on the 0-th row of a coefficient matrix P to be mentioned later.

Now, the first embodiment of the present invention is described. Let us consider four binary complementary sequences with sequence length 4 shown below, instead of the one spreading sequence g(i) as described above.

$$\{ \begin{matrix}{A}_{0} = ( & + & + & + & - ) \\ {A}_{1} = ( & + & - & + & + )\end{matrix} \{ \begin{matrix}{B}_{0} = ( & + & + & - & + ) \\ {B}_{1} = ( & + & - & - & - )\end{matrix}$$

Each of these sequences is applied to a matched filter that matches to the sequence itself and to another matched filter that matches to the associated sequence of the other group, to obtain both-side correlation-functions. Using these outputs, the following added correlation-functions are obtained where j is the shift variable.

$$\begin{matrix}\ddot{{E}_{( A )} ( j ) = {A}_{0} * {\overline{A}}_{0} + {A}_{1} * {\overline{A}}_{1} = {\sum }_{s = - 3}^{3} {p}_{AS} \ddot{d ( j - s )}} & ( 13 ) \\ {\ddot{E}}_{( B )} ( j ) = {B}_{0} * {\overline{B}}_{0} + {B}_{1} * {\overline{B}}_{1} = \sum {p}_{BS} \ddot{d ( j - s )} & ( 14 ) \\ {\ddot{E}}_{( B / A )} ( j ) = {B}_{0} * {\overline{A}}_{0} + {B}_{1} * {\overline{A}}_{1} = {{\sum }^{3}}_{s = - 3} {p}_{CS} \ddot{d ( j - s )} & ( 15 ) \\ {\ddot{E}}_{( A / B )} ( j ) = {A}_{0} * {\overline{B}}_{0} + {A}_{1} * {\overline{B}}_{1} = {{\sum }^{3}}_{s = - 3} {p}_{DS} \ddot{d ( j - s )} & ( 16 )\end{matrix}$$

If the above set of sequences [(A₀,A₁),(B₀,B₁)] are complete complementary sequences, then the values of the right side are given as follows.

$$\begin{matrix}{P}_{AS} = {P}_{BS} = 2 {μ}_{0} {λ}^{0} ( s ) = 2 & ( s = 0 ) \\ = 0 & ( s \neq 0 ) \\ {P}_{CS} = {P}_{DS} = 0 & \end{matrix} \} \qquad ( 17 )$$

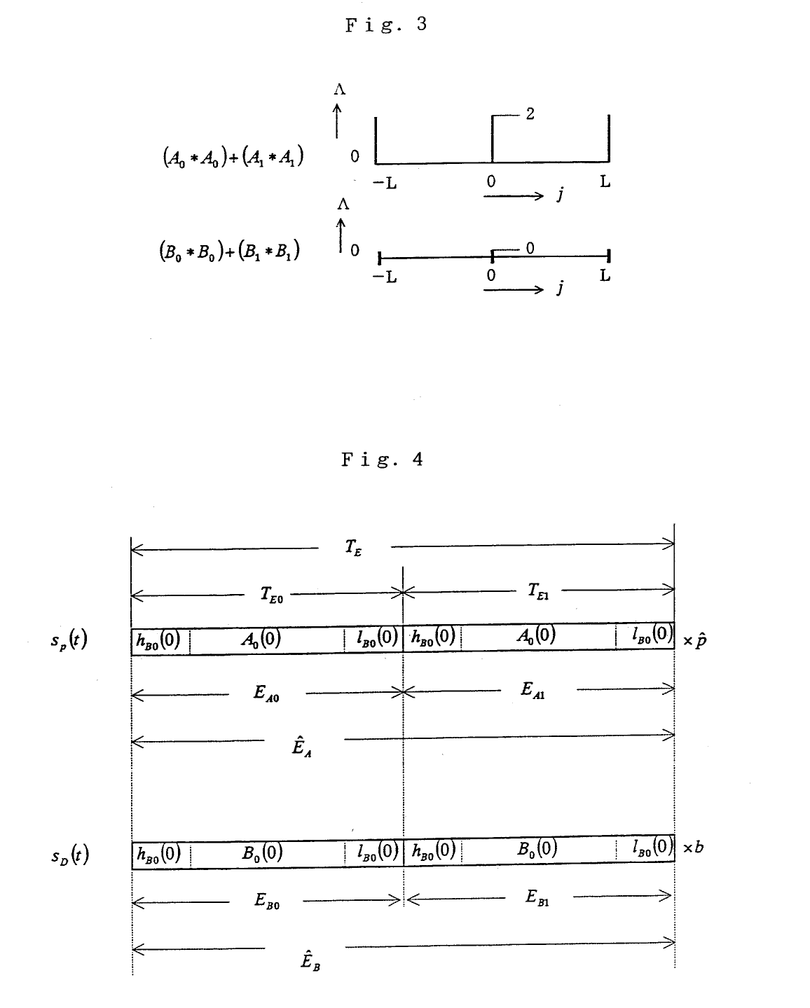

Then, since the 0-shift-value (s=0) of P_{AS} is the sum of the respective 0-shift auto-correlations of A₀ and A₁, it takes 2, assuming the received voltage μ₀=1. FIG. 3(a) shows the characteristics.

On the other hand, since P_{CS} is the sum of the cross-correlation-functions between B₀ and A₀ and between B₁ and A₁, both the functions cancel each other, taking 0 at all the shifts as shown in FIG. 3(b).

From the view point of utilizing the property of the complementary sequences, extended sequences E_{A0} and E_{A1} with sequence length L_{E} such as shown below are considered.

E_{A0}=(h_{A0}A₀l_{A0})

E_{A1}=(h_{A1}A₁l_{A1})

L_{E=L}ₕ+L+Lₗ (18)

The following sequence will be obtained by arranging the above extended sequences in cascade on a time-axis. Ê_{B} can also be obtained by the similar manner.

Ê_{A}=(E_{A0},E_{A1})

Ê_{B}=(E_{B0},E_{B1})

In order to distinguish the component sequences h_{A0}, A₀ of E_{A0} etc. from cyclically shifted sequences to be mentioned later, Ê_{A} is shown in FIG. 2 by the method of displaying h_{A0}(0) and A₀(0) etc.

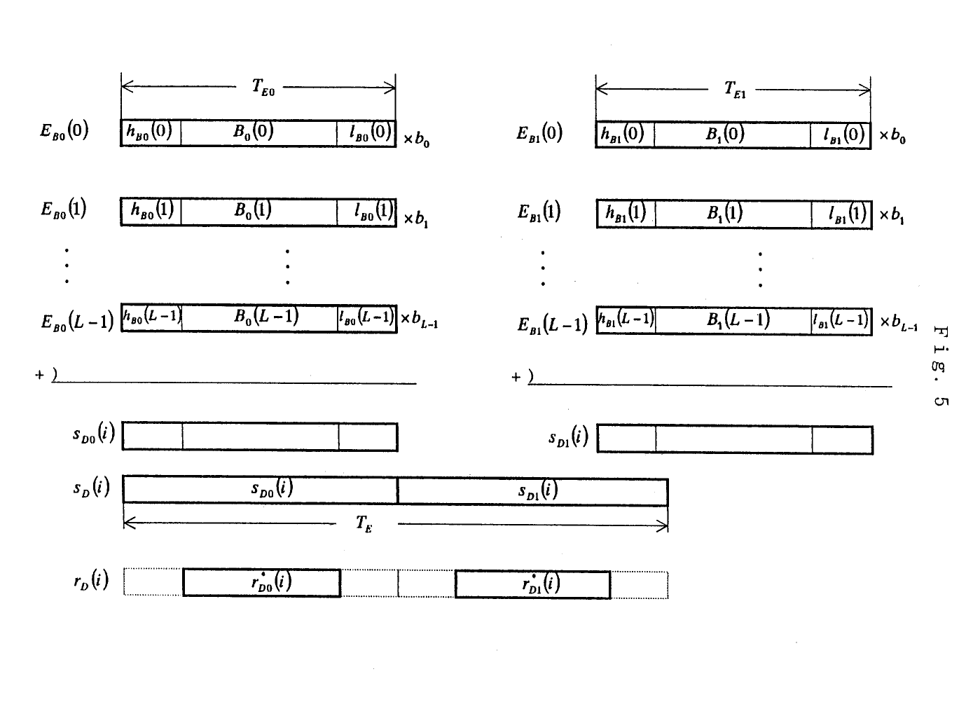

Transmitter TX multiplies the pilot-information p(=1) to these vertical sequences Ê_{A}, and then uses the resultant output to modulate carrier wave with frequency f₀ (it is denoted by f₀), thus producing the transmitting frame given by the following equation shown in FIG. 4. The transmitting frame is then sent out by transmitter TX.

s_{P}(t)=└pÊ_{A}/f₀] (19)

First, assuming that there is no multipath (M=0) in the transmission process. Receiver RX demodulates only the synchronously received wave rₚ*(i) in the received direct wave rₚ(t) corresponding to transmitting frame s_{P}(t), and this output is demodulated by the local carrier wave f₀ (wave rₚ*(i) is multiplied by carrier wave f₀ to produce the low-frequency component thereof) and the following chip output impulse sequence r_{P}(i) which is obtained by correlative demodulation with chip waveforms, is produced,

$$\begin{matrix}{r}_{p}^{*} ( i ) = [ {s}_{p}^{*} ( t ) ] {f}_{0} \\ = [ p {\hat{E}}_{A}^{*} / {f}_{0} ] {f}_{0} \\ = [ {pE}_{A 0}^{*} / {f}_{0} ] {f}_{0} + [ {pE}_{A 0}^{*} / {f}_{0} ] {f}_{0} \\ = p {A}_{0} + p {A}_{1}\end{matrix} \} \qquad ( 20 )$$

where the mark * denotes the frame part with period T_{D} for demodulation included in the synchronously received wave, and [ ]_{f0} denotes demodulation done by carrier wave f₀. It is further assumed that attenuation occurs during transmission is compensated for by receiver RX. The output (pA₀) obtained by demodulating the front part r_{P0}(i) of r_{P}(i) and the output (pA₁) by demodulating the rear part r_{P1}(i) of r_{P}(i) are applied to matched filters MF (A₀) and MF (A₁) which match to sequences A₀ and A₁ respectively. If these outputs Λ_{A0}(j) and Λ_{A1}(j) are added simultaneously, its resultant output is Λ_{A}(j) which denotes the sum between the auto-correlation-function of A₀ and the auto-correlation-function of A₁. This is the characteristic in Eq.(13), (14) and FIG. 3(a). Since r_{P0}(i) is preceded by r_{P1}(i) and the output of MF (A₀) is preceded by the output of MF (A₁), before both the outputs are added, the former output should be delayed by the extended frame period T_{E}. This operation is here expressed as the simultaneous adding. This relationship is also represented by the following equations.

$$\begin{matrix}{A}_{A}^{0} ( j ) = {A}_{A}^{0} ( j ) + {A}_{A1}^{0} ( j ) & \\ = {\sum }_{s = 0}^{L - 1} {p}_{PS} δ ( j - s ) & \\ {p}_{PS} = 2 {μ}_{0} λ ( s ) = 2 & ( s = 0 ) \\ = 0 & ( s \neq 0 )\end{matrix} \} \qquad ( 21 )$$

It should be noted that the actual received wave is composed of a direct wave and M delayed waves as shown by Eq. (10) and is represented as r_{Pf}(i). Thus, the actual correlation-function-output including similar correlation outputs Λ^{m}(j) for the m-th delayed waves is given by, considering the white noise:

$$\begin{matrix}{Λ}_{pf} ( j ) = {\sum }_{m = 0}^{M} 2 {μ}_{m} {Λ}_{A}^{m} ( j ) + {ϵ}_{p} & = & {\sum }_{s = 0}^{L - 1} {p}_{s} δ ( j - s ) + {ϵ}_{p} \\ {p}_{s} = 2 {μ}_{m} & & ( s = m )\end{matrix} \} \qquad ( 22 )$$

where εₚ denotes the noise-related component, μ₀ denotes the received direct wave voltage and μₘ(m≠0) denotes the received delayed wave voltage.

On the other hand, transmitter TX multiplies the transmitting data b₀ by the above-described cascaded sequence Ê_{B}, and then modulates carrier waveform f₀ by the resultant output, thus producing a transmitting frame given by the following equation, that is also shown in FIG. 4.

s_{D}(t)=[b₀Ê_{B}/f₀] (23)

Transmitter TX transmits this frame on the same time slot as the above-described s_{P}(t). Receiver RX extracts the baseband synchronously received waveform r_{D}*(i) on the same time slot as s_{P}(i). In a case without multipath, based on the similar principle described above, the extracted component is given by,

$$\begin{matrix}{r}_{D}^{*} ( i ) = [ {b}_{0} {\hat{E}}_{B}^{*} / {f}_{0} ] {f}_{0} = [ {b}_{0} {E}_{B}^{*} / {f}_{0} ] {f}_{0} + [ {b}_{0} {E}_{B}^{*} / {f}_{0} ] {f}_{0} \\ = {b}_{0} {B}_{0} + {b}_{0} {B}_{1} .\end{matrix} \} \qquad ( 24 )$$

If the front part r₀*(i) of r_{D}*(i) and the rear part r₁*(i) of r_{D}*(i) are applied to matched filters MF (B₀) and MF (B₁) which match to sequences B₀ and B₁ respectively, the correlation outputs Λ_{B0}(j) and Λ_{B1}(j) are obtained. These are added simultaneously by the same manner described above. It results

$$\begin{matrix}{Λ}_{B}^{0} ( j ) & = & {A}_{B0}^{0} ( j ) + {Λ}_{B1}^{0} ( j ) & \\ & = & {b}_{0} \sum {p}_{BS} δ ( j - s ) & \\ {p}_{BS} & = & 2 {μ}_{0} λ ( s ) = 2 & ( s = 0 ) \\ & & = 0 & ( s \neq 0 ) .\end{matrix} \} \qquad ( 25 )$$

Consequently this added output takes 2b₀. In a case of the existence of multipath, the simultaneously added output of matched filters MF (B₀) and MF (B₁) is given by,

$$\begin{matrix}{Λ}_{Df} ( j ) = {\sum }_{m = 0}^{M} 2 {b}_{0} {μ}_{m} {Λ}_{B}^{m} ( j ) + {ϵ}_{D} & = & {\sum }_{s = 0}^{L - 1} {p}_{s} δ ( j - s ) + {ϵ}_{D} \\ {p}_{s} = 2 {μ}_{m} & & ( s = m ) .\end{matrix} \} \qquad ( 26 )$$

This is almost b₀ times as much as the pilot output in Eq.(22). ε_{D} denotes the noise related component.

The received frame r(i) is composed of its front part r₀(i) and rear part r₁(i), when the pilot frame s_{P}(t) and the data frame s_{D}(t) are transmitted on the same time slot. These parts include both the frame components so as to be added. Consequently, these are given by,

$$\begin{matrix}{r}^{*} ( i ) = {r}_{0}^{*} ( i ) + {r}_{1}^{*} ( i ) \\ {r}_{0}^{*} ( i ) = \hat{p} ( {A}_{0} + {A}_{1} ) \\ {r}_{1}^{*} ( i ) = {b}_{0} ( {B}_{0} + {B}_{1} ) .\end{matrix} \} \qquad ( 27 )$$

Hence the actual components applied to the matched filters are

\hat{p}A₀+b₀B₀→MF(A₀),MF(B₀)

\hat{p}A₁+b₀B₁→MF(A₁),MF(B₁).

Therefore, though the simultaneously added output of matched filters MF (A₀) and MF (A₁) contains the component of the sum of cross terms B₀*\overline{A}₀ and B₁*\overline{A}₁, it takes 0 due to the relationship given by Eq.(15). Cross terms contained in the simultaneously added output of the outputs of matched filters MF (B₀) and MF (B₁) also takes 0 due to the relationship given by Eq.(16). Consequently even if s_{P}(t) and s_{D}(t) are transmitted simultaneously, the outputs of Eq.(22) and Eq.(26) obtained when both are transmitted separately do not change. That is to say, both components can be produced separately. Considering the noise related correlation output components ε_{P} and ε_{D} included in the received frame r*(i), the estimate \tilde{b}₀ of the transmitted data b₀ is obtained by the following equation.

$${\tilde{b}}_{0} = \frac{{Λ}_{Df} ( j )}{{Λ}_{Pf} ( j )} = {b}_{0} + ϵ \qquad ( 28 )$$

ε is the deviation given by ε_{P} and ε_{D}.

Then, let us explain such a method that transmitter TX transmits L transmitting data bₙ(n=0, 1, 2, . . . N−1) by the same method as described above, using cyclically shifted complementary sequences (B₀, B₁).

Let us define the cyclically shifted sequence. B₀ is here expressed as B₀(0), and a sequence which is made by cyclically shifting B₀(0) by n chips is described as B₀(n). With the similar expression, extended sequences using the n-shift cyclically shifted sequences are represented by the following equations.

E_{B0}(n)=[h_{B0}(n),B₀(n),l_{B0}(n)]

E_{B1}(n)=[h_{B1}(n),B₁(n),l_{B1}(n)]

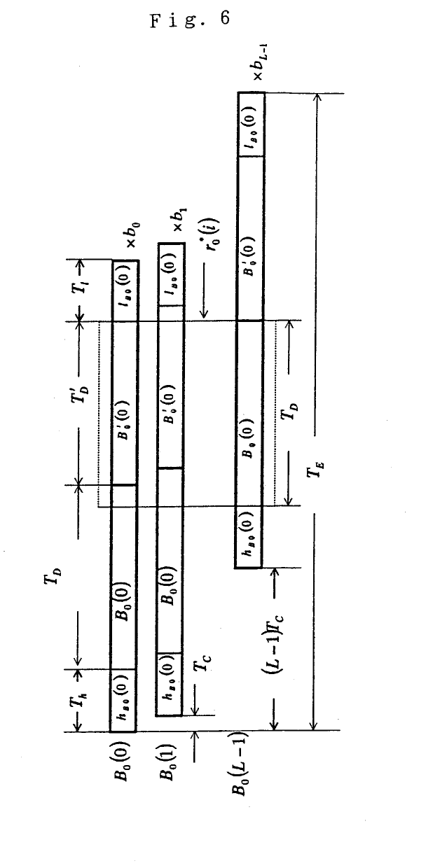

In general, a sequence made by shifting sequence B₀(0) by n chips, its multichips of the left side portion denoted by 1B₀(n), and its multichips of the right side portion denoted by h_{B0}(n) are prepared, and by arranging these sequences in the above-described order, sequence E_{B0}(n) is obtained. L frames are made by multiplying the transmitting data bₙ by sequence Ê_{B}(n) which is made by arranging E_{B0}(n) and E_{B1}(n) in cascade, and then they are synthesized as shown in FIG. 5. A transmitting data-frame thus produced is expressed by,

$$\begin{matrix}{s}_{D} ( t ) = {\sum }_{n = 0}^{L - 1} {s}_{Dn} ( t ) \\ {s}_{Dn} ( t ) = [ {b}_{n} {E}_{B0} ( n ) / {f}_{0} ] + [ {b}_{n} {E}_{B1} ( n ) / {f}_{0} ] = [ {b}_{n} {\hat{E}}_{B} ( n ) / {f}_{0} ] .\end{matrix} \} \qquad ( 29 )$$

L transmitting data-frames are sent using the same time zone and the same frequency slots as those of pilot frame sₚ(t).

Here, let us assume a transmission line which generates multipath waves. Receiver RX receives the following received waves which are the sum of the pilot-frame, the L data-frames and all of the delayed waves generated by the respective frames.

$$\begin{matrix}{r}^{*} ( i ) = {r}_{Pf}^{*} ( i ) + {r}_{Df}^{*} ( i ) + x ( i ) \\ {r}_{Df}^{*} ( i ) = {\sum }_{n = 0}^{L - 1} {r}_{Dnf} ( i ) \\ {r}_{Dnf} ( i ) = {\sum }_{m = 0}^{M} {b}_{n} {μ}_{m} {r}_{Dn} ( i - m )\end{matrix} \} \qquad ( 30 )$$

where r_{Pf}*(i) and r_{Df}*(i) denote the pilot-flock-frame and the data-flock-frame. The respective demodulated outputs of r_{Pf}*(i) and r_{Df}*(i) of r(i) can be separated by the above-described principle. r_{Df}*(i) consist of the L components r_{Dnf}*(i). r_{Dn}*(i−m) is the waveform which is obtained by cyclically shifting bₙÊ_{B}(n) in Eq.(29) by mT_{c}. When r₀*(i) and r₁*(i) composing the synchronously received input r*(i) are applied respectively to the filters MF (B₀) matched to sequence B₀ and MF (B₁) matched to sequence B₁ to generate an output, this output Φ(j) is the sum of component Φⱼ which is made by synthesizing L pieces of correlation function output Λ_{Dmf}(i), each is obtained by multiplying bₙ by Λ_{Pf}(i) in Eq. (22), and component φⱼ corresponding to the white noise related correlation output ε_{D}.

$$\begin{matrix}{Λ}_{Dnf} ( j ) = {\sum }_{s = n}^{n + L - 1} {b}_{n} {p}_{s} δ ( j - s ) + {ϵ}_{D} ( n + L - 1 : mod L ) \\ Φ ( j ) = {\sum }_{n = 0}^{L - 1} {Λ}_{Dnf} ( j ) = {\sum }_{S = 0}^{L - 1} ( {Φ}_{j} + {φ}_{j} ) δ ( j - s )\end{matrix} \} \qquad ( 31 )$$

Defining pilot-response matrix P, unknown matrix \tilde{b}, and data-response matrix Φ as shown below based on the above outputs, the following system of L linear equations L unknowns are derived,

$$\begin{matrix}[ P ] [ \tilde{b} ] = [ Φ ] \\ ( \begin{matrix}{p}_{0} & {p}_{L - 1} & ⋯ & {p}_{1} \\ {p}_{1} & {p}_{0} & ⋯ & {p}_{2} \\ & & & \\ {p}_{L - 1} & {p}_{L - 2} & ⋯ & {p}_{0}\end{matrix} ) ( \begin{matrix}{\tilde{b}}_{0} \\ {\tilde{b}}_{1} \\ \\ {\tilde{b}}_{L - 1}\end{matrix} ) = ( \begin{matrix}{Φ}_{0} + {φ}_{0} \\ {Φ}_{1} + {φ}_{1} \\ \\ {Φ}_{L - 1} + {φ}_{L - 1}\end{matrix} )\end{matrix} \} \qquad ( 32 )$$

where \tilde{b} denotes the sum of the correct transmitted data bₙ and a white noise related error. The n-th unknown \tilde{b}ₙ is solved and the solution is then made in hard-decision to obtain the detected output \hat{b}ₙ.

Here, pilot-response can be transmitted reliably by means of increasing the electric power of the pilot-frame so as to disregard the effect of εₚ in Eq.(22). Consequently, here pₛ is assumed not to contain the error.

By the method above-described, pilot information \hat{p} and L bit transmitting data per user can be transmitted using 2 extended frames with length T_{E} without disturbed by self-interference due to multipath.

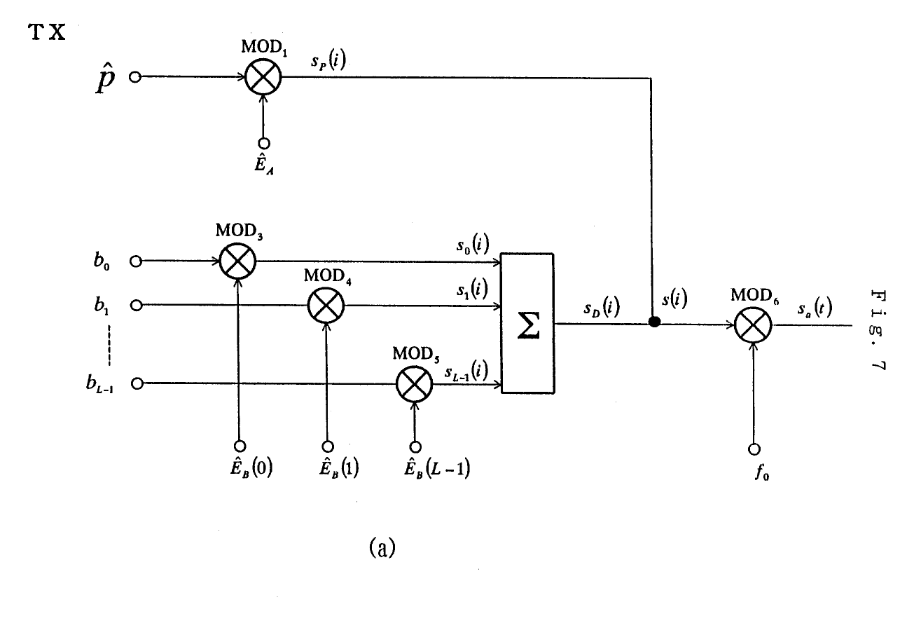

In the manner above-described, although it uses E_{B0}(n) as the cyclically shifted sequence, the sifted sequence of E_{B0}(n) by n chips can be used by taking sufficiently long l(n). The waveform of the data-frame is shown in FIG. 6. Each of L frames is arranged in the time position shifted by 1 chip from the preceding frame. Since the actual tail is the sum of B₀′(0) and l(0) in the figure, T_{E} becomes longer by (L−1)T_{C} than the case in FIG. 5. E_{B1}(n) is also generated similarly. In this case, the similar result above-described can be obtained by the manner that receiver RX extracts a frame on the position equivalent to r₀*(i) in the figure as the front part of the synchronously received frame. This is called chip shift multiple system as contrasted with the cyclically shift multiple system.

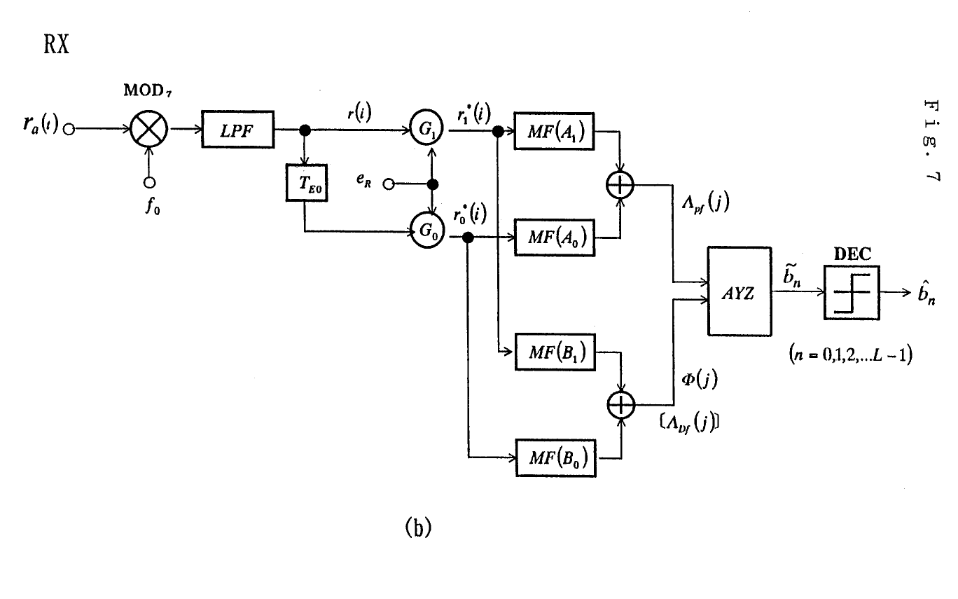

FIG. 7 shows a circuit block diagram of the transmitter and the receiver according to the first embodiment. In FIG. 7(a), symbols MOD₁ to MOD₆ denote modulators and Σ denotes the synthesizer (adder) of the signal. The cascaded sequence Ê_{A} shown in FIG. 4 and Ê_{B} shown in FIG. 5 [a sequence which is made by arranging E_{B0}(n) and E_{B1}(n) in cascade in FIG. 5] are prepared beforehand. FIG. 7(a) shows a circuit of transmitter TX. At modulator MOD₁, the pilot information \hat{p} modulates Ê_{A}, and generates pilot-frame s_{P}(i) on the baseband. On the other hand, at modulators MOD₃ to MOD₅, the transmitting data b₀, b₁ and b_{L-1} modulate Ê_{B}(0), Ê_{B}(1) and Ê_{B}(L−1) respectively, generating transmitting data-sub-frames s₀(i), s₁(i) and s_{L-1}(i). Synthesizer Σ synthesizes these L sub-frames, to generate a transmitting data frame s₀(i). s_{P}(i) and s₀(i) are the impulse sequences, and both are added to make a transmitting frame s(i).

s(i) is multiplied by a chip waveform which is omitted to illustrate. At modulator MOD₆, the transmitting frame on the baseband modulates a carrier wave f₀, and generates a transmitting frame Sₐ(t) on the radio-band. sₐ(t) is transmitted.

FIG. 7(b) shows a circuit of receiver RX. At modulator MOD₇, a received input rₐ(t) corresponding to sₐ(t) is demodulated by the local carrier wave f₀, and the resultant output is converted into the received wave r(t) on the baseband by passing the demodulated output through a low-pass filter LPF. r(t) becomes the received frame r(i) which consists of a chip impulse sequence by the correlative demodulation with the chip waveform which is omitted to illustrate.

r(i) is applied to gate G₀ after a delay time of T_{E0} second given by the delay circuit T_{E0} illustrated. Thus the central part of the front part of r(i) is extracted by a synchronizing signal e_{R} [the frame on the position corresponding to r_{D0}*(i) contained in r_{D}(i) in FIG. 5]. This part becomes r₀*(i). On the other hand, r(i) is added to gate G₁ directly, and the central part of the rear part of r(i) is extracted by e_{R} [the frame on the position corresponding to r_{D1}*(i) in FIG. 5]. This part becomes r₁*(i). These synchronously received frames r₀*(i) and r₁*(i), respectively, consist of the sum of the central parts of the front parts of the pilot-flock-frame and data-flock-frame, r_{P0f}*(i) and r_{D0f}*(i), and the sum of the central parts of the rear parts of the both flock-frames, r_{P1f}*(i) and r_{D1f}*(i).

r₀*(i) is applied to a matched filter MF(A₀) that matches to A₀, on the other side, r₁*(i) is added to a matched filter MF(A₁) that matches to A₁ as illustrated. Outputs of both the matched filters are simultaneously added, to produce the correlation-function output Λ_{pƒ}(j)[Eq.(22)]. On the other hand, r₀*(i) and r₁*(i) are also added to similar filters MF(B₀) and MF(B₁). The simultaneously added output of these filter outputs is Λ_{Df}(j) given by Eq.(26) if transmitted frame s_{D}(i) consists of b₀Ê_{B}(0). However, the simultaneously added output above-described will become Φ(j) in Eq.(31) as illustrated, if s_{D}(i) is the sum of L frames of b_{nÊ}_{B}(n).

Here let us explain the general case taking the latter. Pilot-response Λ_{Pf}(j) and data-response Φ(j) are applied to analyzing circuit AYZ. AYZ generates pilot-response matrix P based on Λ_{Pf}(j), and solves Eq.(32) using Φ(j) and generates unknown \tilde{b}ₙ. Unknown \tilde{b}ₙ is made in hard-decision by decision circuit DEC to detect output \tilde{b}ₙ. In this case, the L transmitting data are detected in a demodulation process for one received frame r(i). Furthermore, a generating circuit of synchronizing signal e_{R} is omitted to explain here.

The frequency utilization-efficiency of the present system can be expressed by the number of chips ν which is required to transmit 1 bit.

$$v = \frac{the number of chips in a cascaded sequence}{the amount of transmitted information} = \frac{2 ( {L}_{h} + L + {L}_{l} )}{L} \qquad ( 33 )$$

The smaller the scale ν is, the more advantageous the present system is. Lₕ/L and L₁/L is determined by the information rate f_{D} and the size of a cell. Let us set the delay time of the delayed waves to 2 μsec by assuming that f_{D}=10 kbps, the cell radius is 1 km, and its propagation time 3 μsec. As a consequence, Tₕ=T₁=2 μsec and 2(Tₕ+T_{D}+T₁)=T_{E}=1/f_{D}=100 μsec are obtained. In this case T_{D}=46 μsec and ν≈2.2chip/bit. This is equivale to 3 to 5 times higher the efficiency than 6 to 10 chips per 1 bit, that is a value of a practical system such as a commercialized system CDMA-one. In the above-described system, it is possible that 1 frame of the N multiple pilot-frames s_{P}(i) is transmitted and the other (N−1) pilot-frames are used for data-frames, because the pilot response does not change rapidly. The value of N decreases, as the transmission data rate reduces, and as the user moving speed increases. Therefore, N can be made larger in case of the high data rate transmission. By setting N>>1, then the value of ν in Eq.(33) reduces to about a half.

The value of ν increases and the efficiency reduces, because T_{E} increases as twice as T_{D} illustrated, when the chip shift multiple system is used. However, when this frame composition is used, covolvers can be used instead of matched filters.

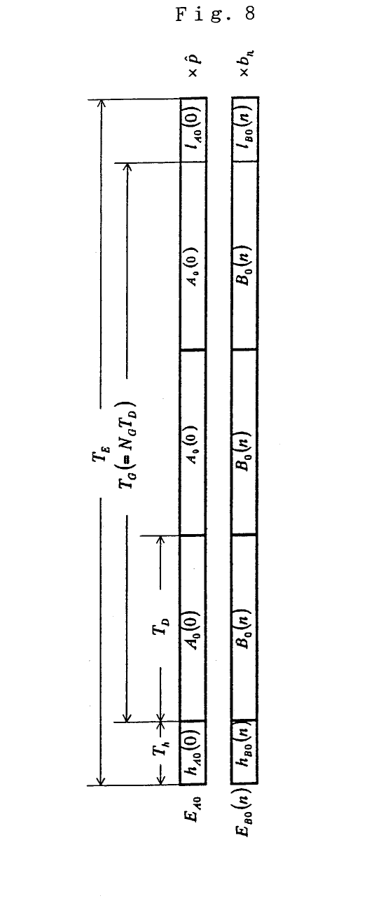

Now, consider, as the second embodiment, a system that Kusers transmit their signals simultaneously. For this case, an example of the extended sequences E_{A0} for pilot and E_{B0}(n) for data used by each user is shown in FIG. 8. A central sequence with time width T_{G} is made by repeating core sequence A₀(0), [B₀(n)] K(=3) times. Extended sequence E_{A0}, [E_{B0}(n)] is composed so that the previously stated header h(0) and tail l(0) may be added to the central sequence. Receiver RX extracts the frame part corresponding to T_{G} as r₀*(i). The spectrum of K times repeated sequence extracted occupies only the L comb slots in KL one-sided frequency slots. Consequently the other (K−1)L frequency slots are vacant.

Here let us define the orthogonal frequency fₖ.

$$\begin{matrix}{f}_{k} = {f}_{0} + k {f}_{G} \\ {f}_{G} = {T}_{G}^{- 1}\end{matrix} \} \qquad ( 34 )$$

The k-th user produces Ê_{A}(0) and Ê_{B}(n)(n=0, 1, 2, . . . L−1) using E_{A0}, E_{A1}, E_{B0}(n) and E_{B1}(n) which are produced by the manner shown in FIG. 8. \hat{P}ₖ and bₖ modulate Ê_{A}(0) and Ê_{B}(n) respectively, and the transmitting frame is produced by the resultant outputs. The above-described orthogonal wave fₖ is modulated by the frame and the modulated output is thus transmitted. The components of respective users contained in r₀*(i) and r₁*(i) which are extracted by receiver RX occupy the individual comb spectrum with L slots so that they can be demodulated without generating cross interference by the following method.

For example, the receiver input frame rₐ(t) is demodulated by the carrier wave f₀ to produce impulse sequence r₀(i), when receiver RX demodulates and detects data b₀ₙ transmitted from u₀. Synchronously received frames r₀*(i) and r₁*(i) are extracted by synchronizing signal e_{R}, and they are applied to matched filters MF(KA₀), MF(KA₁), MF(KB₀) and MF(KB₁) to obtain pilot response {p}₀ and {φ}₀, thereby estimated value \tilde{b}₀ₙ of the data can be derived based on the above-described principle. Thus, the synchronous reception of K users' signals and the L data detection per user can be achieved. In this case, there is no cross-interference between demodulated signals of respective users, as long as the condition of Eq. (11) is maintained, even if a little time difference [τ_{0K} denoted in Eq.(11)] exists between the received waves from respective users. Although the number of chips of the cascaded sequence increase 3 times, the period T_{E} of the symbol-frame is constant as given by the information rate, and the required transmission band-width becomes 3 times larger than the case of k=1. Since the number of users are k→3, the total transmission capacity of the whole system becomes 3 times. Therefore, the value ν of Eq. (33) is invariant. That is to say, such a system that accommodates a large number of users at the same frequency-utilization-efficiency can be constructed.

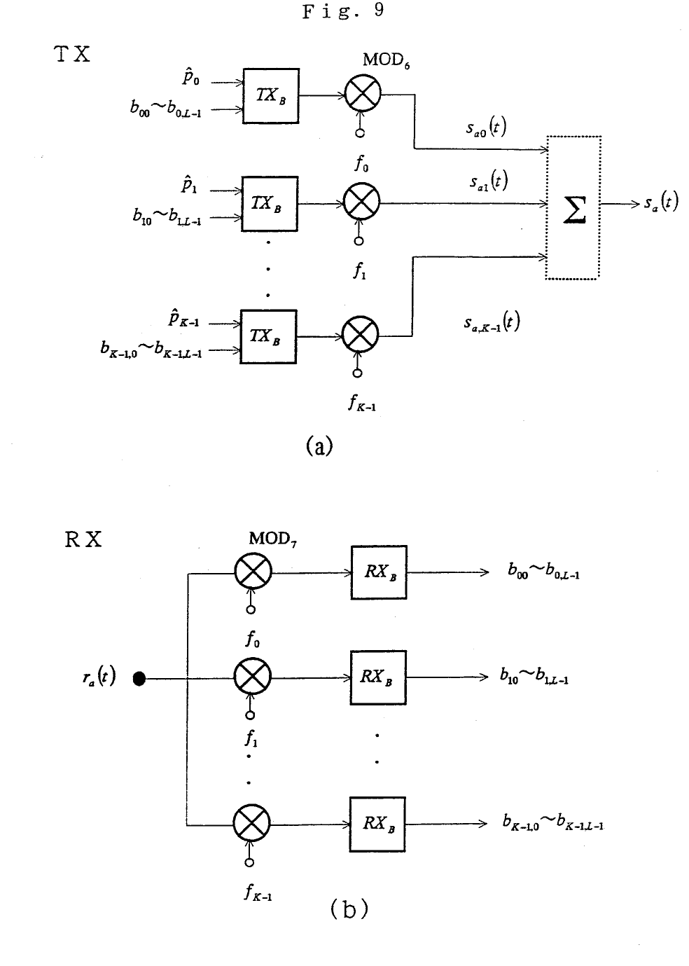

FIG. 9 shows a circuit block diagram of a transmitter and a receiver according to the second embodiment. FIG. 9(a) is the transmitter, and TX_{E} in the figure is the circuit [on condition that the repeated sequences are used for Ê_{A} and Ê_{B}(n) ] of FIG. 7(a) where MOD₆ is removed. That is to say, the k-th user transmitter produces a transmitting frame sₐₖ(t) on the carrier wave fₖ, and transmits it. These frames are admixed in space to make a radio transmitting frame sₐ(t).

FIG. 9(b) is the base station receiver, and RX_{B} in the figure is the circuit [on condition that a circuit matching to repeated sequence KA₀, etc. are used as MF.] of FIG. 7(b) where MOD₇ is removed. In order to demodulate the data has uₖ sent out, received frame rₐ(t) corresponding to sₐ(t) is led to modulator MOD₇ to which fₖ is supplied and the similar demodulating operation as FIG. 7(b) is performed at RX_{B}. The system accommodating K users described above can be constructed by such a transmitter and a receiver as explained here.

In the above-described description, it is possible to use multi-value, real number or complex (polyphase) sequences with the complementary characteristics, though binary sequences have been used so for as the spreading-sequences. The similar function can be performed using not only the complementary sequences of 2 sequences×2 sets but also the plural sequence set like 4 sequences×4 sets, etc. There is an advantage the accuracy of a D/A converter placed at the transmitter output side and an A/D converter placed at the receiver input side can be mitigated when complementary sequences with canceling effect of the correlation outputs are used.

Furthermore, although the examples using the complementary sequences are explained as the main subject here, an arbitrary selected sequence (for example, an M sequence) as the spreading sequence can be used for the pilot-frame (Fₚ) and the data-frame (F_{D}) at transmitter. That is to say, a cascaded sequence is made by using the two frames above-described are transmitted, and it is sent out. Here, F_{D} is a sum of L frames produced by using the cyclically shifted sequences. This is extracted in time division manner as separate frames at the receiver, and using the former the pilot-response Λ_{Pf} or Φ is obtained. In this case, element pₛ of Λ_{Pf} does not take the simple expression (pₛ₌2 μm) shown in Eq.(26). But L pₛ can be obtained as the correlation output between the above-described M sequence and the pilot-frame. \tilde{b}ₙ and \hat{b}ₙ can be obtained based on the above-described principle, if a pilot matrix P is produced with response Λ_{Pf}. Moreover although the transmission data b has been assumed to take a binary, it is also possible to transmit data having a multi-value or a complex number.

In addition, it is also possible to use L difference kinds of sequences gₗ(i)=[l=0, 1, 2, . . . L−1] with sequence length L generally, instead of using the above-described cyclically shifted sequences as the core sequences constituting F_{D}. In this case, the analyzing sequence ĝ₀(i) (generally it is a real number sequence) which is orthogonal with g₀(i) except at the 0 shift is obtained, when adopting g₀(i) as the core sequence for the pilot-frame. The pilot responses calculates pₗ₀, pₗ₁, p₁₂, . . . corresponding to other sequence gₗ(i)(k≠0) to produce the pilot matrix P by these responses, when it uses the pilot responses p₀₀, p₀₁, p₀₂, . . . which are obtained by applying this pilot-frame to matched filter MF[ĝ₀(i)]. Consequently, the multiple communication systems can be constructed based on the above-described principle.

As described above, the present invention is characterized by that a transmitter transmits a signal which conveys multiplexed data put on cyclically shifted or chip shifted spreading sequences made by using one set of complementary sequences, or put on mutually different sequences, and a receiver can separate and discriminate the multiplexed data, based on, for instance, received pilot responses of pilot frames made by using, for instance, the other set of the complementary sequences. Moreover, a system using optional sequences instead of the complementary sequences or another system using the mutually different sequences instead of the cyclically shifted sequences can be constructed. Consequently, the frequency-utilization-efficiency can be increased compared with conventional CDMA systems. When the present invention is applied to mobile communications systems, radio LANs, etc., it is very effective in increasing the capacity of the systems by improving the frequency-utilization-efficiency.

1. A cyclically shifted code division multiple access communications system is characterized, in a direct-sequence spread-spectrum CDMA communications system that each transmitter comprises a function of generating extended sequences which are composed by arranging a rear and a front portions of a core-spreading-sequence or zero sequences respectively at the front and the rear outsides of the core-spreading-sequence as guard-sequences,
a function of modulating the extended sequences with transmitting information to produce a transmitting data-frame,
a function of modulating the extended sequences with pilot information to produce an isolated pilot-frame that is not affected by data-frames and pilot-frames transmitted by the other transmitters, and
a function of transmitting data and isolated pilot-frames; and
a receiver comprises a function of receiving a synchronously received data-flock-frame on a position synchronized with the core-sequence in the extended sequence coming from the desired station,
a function of receiving a similar synchronously received isolated pilot-flock-frames,
a function of analyzing both the flock-frames, generating the received data-response and pilot-response,
the transmitter comprises means of generating the 4 extended sequences E_{A0}, E_{A1}, E_{B0} and E_{B1} using a set (A₀,A₁) of the auto-complementary sequences with sequence length L chips composed the complete complementary sequences having the complete complementary characteristics each other and another similar set (B₀,B₁),
means of generating a transmitting pilot frame sₚ made by multiplying a cascaded sequence Ê_{A} composed of the extended sequences E_{A0} and E_{A1} by a pilot information \hat{p}, generating a transmitting frame S_{D} made by multiplying a cascaded sequence Ê_{B} composed of the extended sequences E_{B0} and E_{B1} by a data b, synchronously adding both the multiplied outputs to produce a symbol frame, and transmitting a carrier wave modulated by said frame, and
the receiver comprises means of applying a front portion r₀ of the synchronously received baseband frame demodulated by above-described carrier wave to a filter M(A₀) that matchs to A₀, applying a rear portion r₁ of the synchronously received frame to a filter M(A₁) that matches to A₁, and generating a pilot-response matrix {p} corresponding to pilot information \hat{p} by adding both the matched filter outputs synchronously,
means of applying front portion r₀ and rear portion r₁ of the synchronously received frame to similar matched filters M(B₀) and M(B₁) respectively, and generating the received data-response-matrix Φ corresponding to the data b by adding those outputs synchronously,
means of generating an estimate \tilde{b} of the transmitted data from which the influence of the preceding or delayed waves due to multipath is removed, using pilot response {p} and received data response matrix Φ, and means of detecting the transmitted data \hat{b} by making estimate \tilde{b}ₓ on the hard-decision.

2. A cyclically shifted code division multiple access communications system according to claim 1 is characterized in that the transmitter comprises means of generating cascaded sequence Ê_{B}(n) made of extended sequences E_{B0}(n) and E_{B1}(n) which are obtained by cyclically shifting extended sequences E_{B0} and E_{B1} by n(=0, 1, 2, . . . L−1) chips, producing a transmitting frame sₙ by multiplying cascaded sequence Ê_{B}(n) by data bₙ, producing a transmitting symbol frame by adding L pieces of sₙ and pilot frame sₚ according to claim 1 synchronously, and transmitting a carrier wave modulated by said transmitted symbol frame, and
the receiver comprises means of applying front portion r₀ and rear portion r₁ of the synchronously received frame to matched filters M[B₀(n)] and M[B₁(n)] that matches to sequence B₀(n) which is obtained by cyclically shifting core sequence B₀ by n chips and similar sequence B₁(n) respectively, producing received response matrix Φ by synchronously adding said matched filter outputs, solving a system of linear equations composed of Φ, pilot matrix P generated by above-described {p} and an unknown matrix \tilde{b}(n), and detecting L data by making solved data estimates \tilde{b}(n) on the hard-decision.

3. A cyclically shifted code division multiple access communications system according to claim 1 is characterized in that the transmitter comprises means of producing the extended sequence E_{A0K} with period T_{E} by arranging guard sequences at the front and the rear outside of a repeated core-sequence with time width T_{G} which is made by repeating core-sequence A₀ by K times, generating extended sequences E_{A0K}, E_{A1K}, E_{B0K} and E_{B1K} using complementary sequences,
means of generating a cascaded sequence Ê_{AK} made of extended sequences E_{A0K} and E_{A1K}, and a cascaded sequence Ê_{BK} made of extended sequences E_{B0K} and E_{B1K}, generating modulated frames Ê_{AK}/fₖ and Ê_{BK}/fₖ obtained by modulating orthogonal carrier waves fₖ(k=0, 1, 2, . . . K−1) whose frequencies are different one another by integer times of the reciprocal of core frame period T_{G} by cascaded sequences Ê_{AK} and Ê_{BK}, generating a transmitting frame sₚₖ by modulating Ê_{AK}/fₖ by pilot information \hat{P}ₖ and a transmitting frame s_{Dk} by modulating Ê_{BK}/fₖ by data bₖ, and transmitting said transmitting frames synchronously, and
the receiver comprises means of applying front portion r₀ and rear portion r₁ of the synchronously received frame to matched filters M(KA₀/fₖ), M(KB₀/fₖ), M(KA₁/fₖ) and M(KB₁/fₖ) that match to the above-described repeated core sequences on carrier wave fₖ respectively, generating pilot matrix {p}ₖ of the k-th user uₖ and data response matrix Φₖ of uₖ by adding synchronously the former two matched filter outputs and the latter two matched filter outputs, respectively, and obtaining estimate \tilde{b}ₖ of transmitted data bₖ by solving a system of linear equations composed of these matrices.

4. A cyclically shifted code division multiple access communications system according to claim 3 is characterized in that the transmitter generates cascaded sequence Ê_{B}(n) made of extended sequences E_{B0}(n) and E_{B1}(n) which are obtained by cyclically shifting the extended sequences E_{B0} and E_{B1} by n(=0, 1, 2, . . L−1) chips, and composing a transmitting frame obtained by modulating cascaded sequence Ê_{BK}(n) on orthogonal carrier wave fₖ by transmitting data bₖₙ(0, 1, 2, . . . L−1) of user uₖ, and
the receiver applies front portion r₀ and rear portion r₁ of the synchronously received frame to matched filters M[B₀(n)] and M[B₁(n)] that match to sequence B₀(n) which is obtained cyclically shifting by n chips of core sequence B₀ and to similar sequence B₁(n) respectively, producing received response matrix Φ which is obtained by synchronously adding said matched filter outputs, solving a system of linear equations composed of Φ, pilot matrix P generated by above-described {p} and an unknown matrix \tilde{b}(n), and demodulating data bₖₙ which user uₖ has transmitted, in a process of detecting L data by making solved data estimate \tilde{b}(n) on the hard decision.

5. A cyclically shifted code division multiple access communications system according to claim (3) or (4) is characterized in that Q(=2, 3, . . . ) pieces of orthogonal carrier waves is assigned to the data transmission for user uₖ, and the receiver demodulates using a common pilot information thereby the transmission capacity of each user is increased.

6. A cyclically shifted code division multiple access communications system according to claim 1 is characterized in that the pilot information is transmitted once in multiple N frames, and the data information is transmitted using the other (N−1) frames.

7. A cyclically shifted code division multiple access communications system according to claim 5 is characterized in that the pilot information is transmitted once in multiple N frames, and the data information is transmitted using the other (N−1) frames.
